(19) United States
(12) Patent Application Publication
(10) Pub. No.: US 2023/0311541 A1
(43) Pub. Date: Oct. 5, 2023

(54) RECORDING DEVICE

(71) Applicant: SEIKO EPSON CORPORATION, Tokyo (JP)

(72) Inventors: Morio IWATA, Matsumoto-shi (JP); Shumi KARASAWA, Matsumoto-shi (JP); Kazuo SAITO, Shiojiri-shi (JP); Yuka SHIMIZU, Shimosuwa-machi (JP)

(21) Appl. No.: 18/193,495

(22) Filed: Mar. 30, 2023

(30) Foreign Application Priority Data
Apr. 1, 2022 (JP) 2022-061688

(51) Int. Cl. B41J 11/00; B41J 2/17; B41J 2/175; B41J 11/02

(52) U.S. Cl. CPC B41J 11/0065; B41J 2/1721; B41J 2/17596; B41J 11/007; B41J 11/02

(57) ABSTRACT

A recording device includes an ejecting head ejecting ink onto a medium, a first ink absorber disposed at a position facing the ejecting head and absorbing waste ink, among the ink, ejected to a position beyond an edge during borderless recording, a platen configured to supports the first ink absorber, and support the medium during the borderless recording, a first waste ink tray including a first discharge port discharging the waste ink, the first waste ink tray receiving the waste ink flowing out from the first ink absorber, and a discharge mechanism discharging, from the first discharge port, the waste ink received by the first waste ink tray, wherein the first waste ink tray includes a plurality of inclined regions inclined to guide the waste ink to the first discharge port, and each of the plurality of inclined regions has a different inclination direction.

The present application is based on, and claims priority from JP Application Serial Number 2022-061688, filed Apr. 1, 2022, the disclosure of which is hereby incorporated by reference herein in its entirety.

### BACKGROUND

### 1. Technical Field

The present disclosure relates to a recording device.

### 2. Related Art

Various recording devices have been used. Some of these recording devices can perform borderless for forming an image up to the edge of a medium. For example, JP-A-2002-225311 discloses a color printer in which a groove portion is formed in a platen, the groove portion receiving waste ink ejected to a position beyond the edge of a medium during borderless recording so that the platen supporting the medium is not made dirty due to the borderless recording.

Some of the recording devices capable of performing borderless recording for forming an image up to the edge of a medium are small and easily movable, examples of which include a recording device specialized in recording of a photograph. In such recording devices, constituent members such as a tray for receiving waste ink caused by borderless recording are also desired to be small. However, in most recording devices in the related art, a bottom surface of a constituent member that receives waste ink is configured as a horizontal surface, the waste ink cannot be efficiently discharged from the constituent member, and a waste ink collecting mechanism including the constituent member and the like tend to be large. In this manner, it is desired to efficiently collect waste ink for, for example, downsizing of a waste ink collecting mechanism.

### SUMMARY

A recording device according to an aspect of the present disclosure is a recording device configured to perform borderless recording for forming an image up to an edge of a medium, the recording device including an ejecting head configured to eject ink onto the medium, a first ink absorber, during the borderless recording, disposed at a position facing the ejecting head and configured to absorb waste ink, of the ink, ejected to a position beyond the edge, a platen configured to support the first ink absorber, and support the medium during the borderless recording, a first waste ink tray including a first discharge port configured to discharge the waste ink, the first waste ink tray being configured to receive the waste ink flowing out from the first ink absorber, and a discharge mechanism configured to discharge, from the first discharge port, the waste ink received by the first waste ink tray, wherein the first waste ink tray includes a plurality of inclined regions that are inclined to guide the waste ink to the first discharge port, and each of the plurality of inclined regions has a different inclination direction.

### BRIEF DESCRIPTION OF THE DRAWINGS

FIG. 1 is a perspective view of a recording device according to an embodiment of the present disclosure.

FIG. 2 is a side cross-sectional view illustrating an internal configuration of the recording device of FIG. 1.

FIG. 3 is a perspective view illustrating a vicinity of a first ink absorber at a position facing an ejecting head of the recording device of FIG. 1.

FIG. 4 is a front cross-sectional view illustrating the vicinity of the first ink absorber of the recording device of FIG. 1.

FIG. 5 is a perspective view illustrating a vicinity of a first waste ink tray in which the first ink absorber, an electrode plate, and a platen are removed from the recording device of FIG. 1.

FIG. 6 is a plan view illustrating the vicinity of the first waste ink tray in which the first ink absorber, the electrode plate, and the platen are removed from the recording device of FIG. 1.

FIG. 7 is a plan view illustrating a positional relationship between the first ink absorber and the first waste ink tray of the recording device of FIG. 1.

FIG. 8 is a plan view illustrating the first waste ink tray of the recording device of FIG. 1 and illustrates a state in which a second ink absorber is removed.

FIG. 9 is a side cross-sectional view illustrating the first waste ink tray of the recording device of FIG. 1 and illustrates a state in which the second ink absorber is removed.

FIG. 10 is a front cross-sectional view illustrating the first waste ink tray of the recording device of FIG. 1 and illustrates a state in which the second ink absorber is removed.

FIG. 11 is an enlarged view of a region a of FIG. 10.

FIG. 12 is a plan view illustrating the first waste ink tray of the recording device of FIG. 1 and illustrates a state in which the second ink absorber is attached.

FIG. 13 is a plan view illustrating a vicinity of the electrode plate in a state in which the first ink absorber is removed from the recording device of FIG. 1.

FIG. 14 is a plan cross-sectional view illustrating a vicinity of an electrode terminal of the electrode plate of the recording device of FIG. 1 and a wiring line coupled to the electrode terminal.

FIG. 15 is a perspective view illustrating a vicinity of the wiring line coupled to the electrode terminal of the electrode plate of the recording device of FIG. 1.

### DESCRIPTION OF EXEMPLARY EMBODIMENTS

First, the present disclosure will be schematically described.

A recording device according to a first aspect of the present disclosure is a recording device configured to perform borderless recording for forming an image up to an edge of a medium, the recording device including an ejecting head configured to eject ink onto the medium, a first ink absorber, during the borderless recording, disposed at a position facing the ejecting head and configured to absorb waste ink, among the ink, ejected at a position beyond the edge, a platen configured to support the first ink absorber, and support the medium during the borderless recording, a first waste ink tray including a first discharge port configured to discharge the waste ink, the first waste ink tray being configured to receive the waste ink flowing out from the first ink absorber, and a discharge mechanism configured to discharge, from the first discharge port, the waste ink received by the first waste ink tray, wherein the first waste ink tray includes a plurality of inclined regions that are inclined to guide the waste ink to the first discharge port, and each of the plurality of inclined regions has a different inclination direction.

According to this aspect, the first waste ink tray that receives the waste ink caused by the borderless recording includes the plurality of inclined regions inclined to guide the waste ink to the first discharge port. Each of the plurality of inclined regions has a different inclination direction. With such a configuration, the waste ink received by the first waste ink tray can be effectively guided to the first discharge port. Thus, the waste ink caused by the borderless recording can be efficiently collected.

In the first aspect, a recording device according to a second aspect of the present disclosure includes a transport unit configured to transport the medium in a transport direction, wherein the first waste ink tray includes, as the plurality of inclined regions, a first inclined surface inclined in the transport direction and a second inclined surface inclined in a width direction intersecting the transport direction.

According to this aspect, the first waste ink tray includes, as the inclined regions, the first inclined surface inclined in the transport direction and the second inclined surface inclined in the width direction. Thus, the waste ink can be effectively guided to the first discharge port from greatly different directions, and the waste ink can be particularly efficiently collected. In addition, since the inclined regions are configured as surfaces, it is possible to suppress the first waste ink tray becoming bulky and large.

In the first or second aspect, a recording device according to a third aspect of the present disclosure is a recording device wherein the first waste ink tray includes, in at least one of the plurality of inclined regions, a groove extending along the inclination direction.

According to this aspect, the first waste ink tray includes, in at least one of the plurality of inclined regions, the groove extending along the inclination direction. Providing the groove enables the waste ink to be effectively guided to the first discharge port using, for example, the capillary effect. Thus, the waste ink can be particularly efficiently collected.

In the first or second aspect, a recording device according to a fourth aspect of the present disclosure is a recording device wherein the discharge mechanism includes a waste ink storage unit configured to store the waste ink, and a first tube coupling the first discharge port and the waste ink storage unit.

According to this aspect, the discharge mechanism includes the waste ink storage unit configured to store the waste ink, and the first tube coupling the first discharge port and the waste ink storage unit. With such a configuration, for example, by making the first tube flexible, it is possible to increase the degree of freedom in the arrangement of the waste ink storage unit.

In the fourth aspect, a recording device according to a fifth aspect of the present disclosure is a recording device wherein the discharge mechanism includes a pump configured to accelerate a flow of the waste ink from the first discharge port to the waste ink storage unit via the first tube.

According to this aspect, provided is the pump configured to accelerate the flow of the waste ink from the first discharge port to the waste ink storage unit via the first tube. Thus, the waste ink can be particularly quickly and efficiently discharged to the waste ink storage unit by using the pump. In addition, use of the pump enables the waste ink storage unit to be disposed above the first discharge port in the gravitational direction, which can increase the degree of freedom of the device configuration.

In the fifth aspect, a recording device according to a sixth aspect of the present disclosure is a recording device wherein the ejecting head is configured to eject the ink onto the medium while reciprocating, the ejecting head being located at a home position during non-recording, a second waste ink tray configured to receive the ink ejected from the ejecting head as waste ink is provided at the home position, the second waste ink tray includes a second discharge port, the discharge mechanism includes a second tube coupling the second discharge port and the waste ink storage unit, and the pump also has a role of accelerating a flow of the waste ink from the second discharge port to the waste ink storage unit via the second tube.

According to this aspect, the pump has a role of not only accelerating the flow of the waste ink from the first discharge port to the waste ink storage unit via the first tube, but also accelerating the flow of the waste ink from the second discharge port to the waste ink storage unit via the second tube. This eliminates necessity of providing a plurality of the pumps and thus can suppress upsizing of the device.

In the first or second aspect, a recording device according to a seventh aspect of the present disclosure is a recording device wherein the first ink absorber includes a contact portion in contact with the first waste ink tray.

According to this aspect, the first ink absorber includes the contact portion in contact with the first waste ink tray. Thus, the waste ink can be efficiently moved from the first ink absorber to the first waste ink tray via the contact portion. Thus, the waste ink can be particularly efficiently collected.

In the second aspect, a recording device according to an eighth aspect of the present disclosure is a recording device wherein a width of the first waste ink tray when viewed from the transport direction is narrower than a width of the first ink absorber when viewed from the transport direction.

According to this aspect, the width of the first waste ink tray when viewed from the transport direction is narrower than the width of the first ink absorber when viewed from the transport direction. This can downsize the first waste ink tray and thus can downsize the entire device.

In the first or second aspect, a recording device according to a ninth aspect of the present disclosure includes a second ink absorber provided around the first waste ink tray as viewed from an ejection direction of the ink.

According to this aspect, the second ink absorber is provided around the first waste ink tray as viewed from the ejection direction of the ink. Thus, for example, when the recording device is moved in a state in which the waste ink remains in the first waste ink tray, it is possible to suppress the waste ink leaking from the first waste ink tray and making the inside of the device dirty.

In the first or second aspect, a recording device according to a tenth aspect of the present disclosure includes an electrode plate including an electrode terminal coupled to a wiring line, the electrode plate being provided at a position between the platen and the first ink absorber, and a third ink absorber provided along the wiring line.

According to this aspect, the third ink absorber is provided along the wiring line coupled to the electrode terminal of the electrode plate. Thus, it is possible to suppress the waste ink leaking from the first waste ink tray along the wiring line and making the inside of the device dirty.

Details of the present disclosure will be described below. In each of the drawings, a direction along an X-axis is a device width direction, and is a direction intersecting a transport direction of a medium, that is, a width direction. A −X direction is a right direction, and a +X direction is a left direction as viewed from a user when a front surface of the device faces the user. A direction along a Y-axis is a device depth direction, and a +Y direction is a direction from the back toward the front of the device. A −Y direction is a direction from the front toward the back of the device. A direction along a Z-axis is a vertical direction, a +Z direction is a vertically upward direction, and a −Z direction is a vertically downward direction.

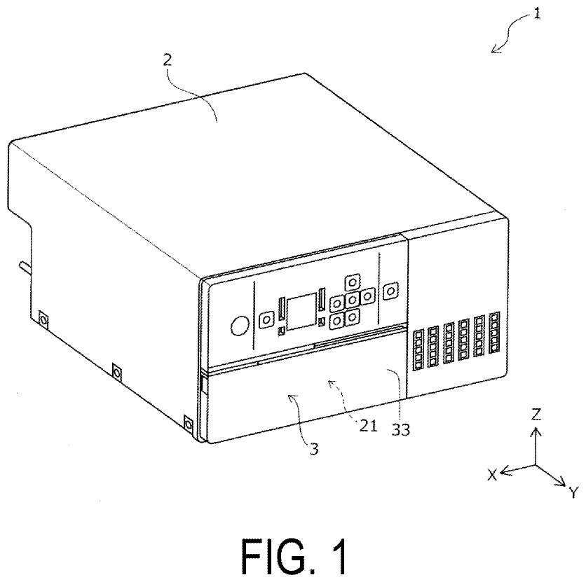

First, an appearance of a recording device 1 according to an embodiment of the present disclosure will be described with reference to FIG. 1. The recording device 1 according to the embodiment illustrated in FIG. 1 is, for example, an ink jet printer for performing recording on a photographic recording medium having a size of, for example, 6 inches×4 inches. However, the present disclosure is not limited to an ink jet printer for performing recording on a photographic recording medium.

As illustrated in FIG. 1, the recording device 1 includes a main body 2 and a medium accommodation unit 3 attachable to and detachable from the main body 2. Here, the medium accommodation unit 3 can be attached to the main body 2 by being inserted into the main body 2 through an opening portion 21 provided at the front surface of the main body 2, and can be detached from the main body 2 by being pulled out from the main body 2 through the opening portion 21. That is, the attachment direction of the medium accommodation unit 3 to the main body 2 is the −Y direction, and the detachment direction of the medium accommodation unit 3 from the main body 2 is the +Y direction.

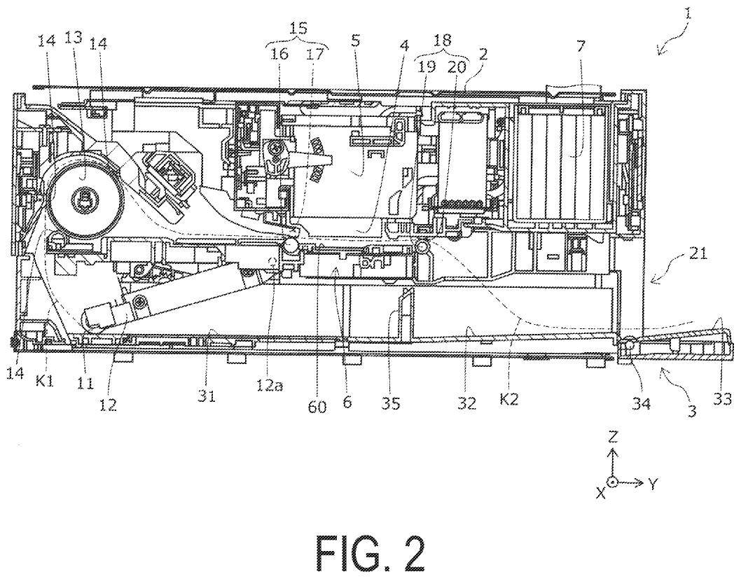

Next, an internal configuration of the recording device 1 will be described with reference to FIG. 2 from the viewpoint of a transport path of the medium. As illustrated in FIG. 2, the opening portion 21 is provided at the front surface of the main body 2, and the medium accommodation unit 3 can be attached to the main body 2 by being inserted in the −Y direction into the main body 2 through the opening portion 21, and can be detached from the main body 2 by being pulled out in the +Y direction from the main body 2 through the opening portion 21.

The medium accommodation unit 3 includes a first region 31 that accommodates a pre-recording medium that is a medium before recording, and a second region 32 that accommodates a recorded medium after recording is performed by an ejecting head 4 serving as a recording unit described later. The first region 31 and the second region 32 are partitioned by a partition wall 35. The presence of the partition wall 35 can suppress the pre-recording medium and the recorded medium being mixedly placed. In addition, the medium accommodation unit 3 includes an opening/closing cover 33 that can be opened and closed relative to a rotation shaft 34 in a state in which the medium accommodation unit 3 is attached to the main body 2. The opening/closing cover 33 is brought into an open state as illustrated in FIG. 2 and thereby an end portion of the recorded medium in the +Y direction can be placed at the opening/closing cover 33, and the opening/closing cover 33 is brought into a closed state as illustrated in FIG. 1 and thereby the opening portion 21 can be closed by the opening/closing cover 33.

A transport path of the medium will be described below. The recording device 1 according to the embodiment transports the pre-recording medium accommodated in the first region 31 to a position facing the ejecting head 4 along a transport path K1, performs recording by the ejecting head 4, and then transports the recorded medium to the second region 32 along a transport path K2. The recording device 1 according to the embodiment includes a feeding roller 11 at a position facing the first region 31 in a state in which the medium accommodation unit 3 is attached to the main body 2. The feeding roller 11 is supported by a supporting member 12 that swings about a swing shaft 12a, and the swing of the supporting member 12 advances and retreats the feeding roller 11 toward and from the pre-recording medium accommodated in the first region 31.

The pre-recording medium accommodated in the first region 31 is transported along the transport path K1 by the feeding roller 11 to a position facing a rotating roller 13. A plurality of driven rollers 14 are provided around the rotating roller 13. The pre-recording medium is transported while being nipped between the rotating roller 13 and the driven rollers 14, and thus transported to a nip position of a transport roller pair 15 including a driving roller 16 and a driven roller 17 along the transport path K1.

At a position facing the ejecting head 4, recording is performed on the pre-recording medium transported to the nip position of the transport roller pair 15 along the transport path K1. The ejecting head 4 according to the embodiment is provided at a carriage 5 that reciprocates in the X-axis direction, and is a so-called serial-type ink jet head that ejects ink while reciprocating in the X-axis direction together with the carriage 5. A predetermined amount of transport by the transport roller pair 15 and an operation in which the ejecting head 4 ejects ink while reciprocating in the X-axis direction are repeated, and thus recording is performed on the pre-recording medium transported to the position facing the ejecting head 4. As a result, a recorded medium is generated.

A front end portion, in the transport direction, of the recorded medium on which the recording has been performed by the ejecting head 4 is transported to a nip position of a discharge roller pair 18 including a driving roller 19 and a driven roller 20. Then, the recorded medium is discharged along the transport path K2 to the second region 32 by the discharge roller pair 18.

Here, the recording device 1 according to the embodiment is a recording device capable of performing borderless recording for forming an image up to the edge of the medium. A platen 60 supporting the medium during recording is provided at a position 6 facing the ejecting head 4. At the position 6 facing the ejecting head 4, a portion of the platen 60 corresponding to the edge of the medium is configured to be lower than a portion of the platen 60 supporting the medium so that ink does not adhere to the surface of the platen 60 and the ink adhering to the surface of the platen 60 does not adhere to the medium and stain the medium in the borderless recording.

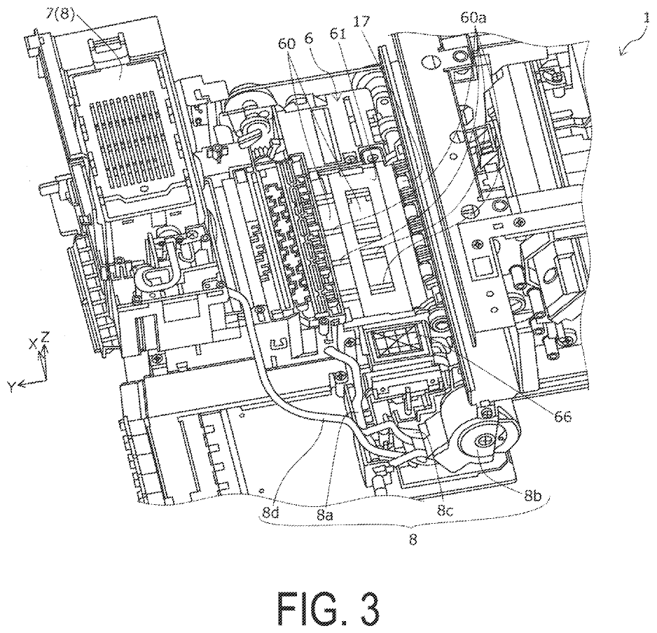

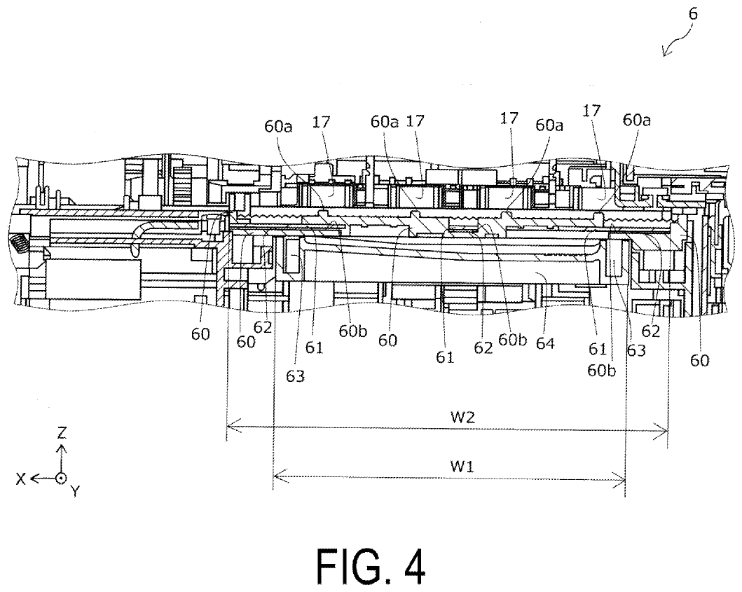

A detailed configuration of the position 6 facing the ejecting head 4 will be described in detail below with reference to FIGS. 3 to 15. As illustrated in FIGS. 3 and 4, ribs 60a are formed at a surface of the platen 60, and the medium is supported by the ribs 60a at the position 6 facing the ejecting head 4. As illustrated in FIG. 4, a recessed portion 60b recessed in the −Z direction is formed at the surface of the platen 60, and a first ink absorber 61 is disposed at the recessed portion 60b. The first ink absorber 61 is disposed at a position facing the ejecting head 4 and absorbs, among ink ejected from the ejecting head 4, waste ink ejected to a position beyond the edge of the medium during borderless recording.

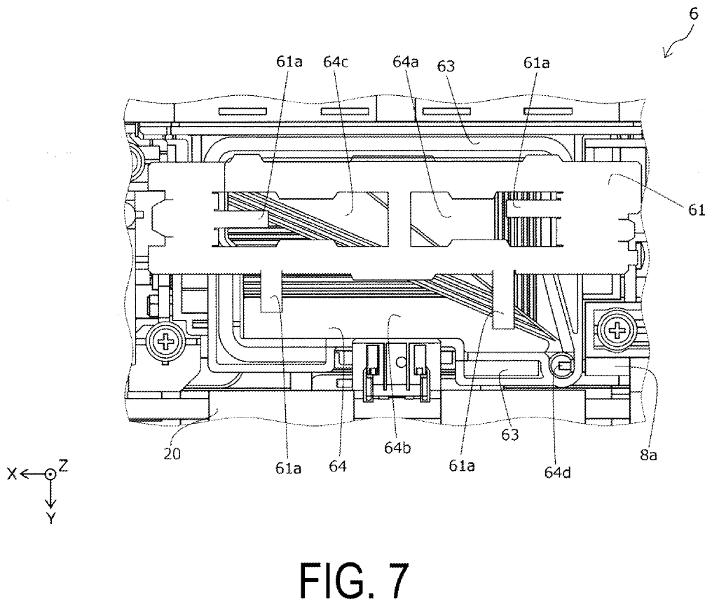

As illustrated in FIGS. 4, 5 and 6 and the like, a first waste ink tray 64 for receiving the waste ink flowing out from the first ink absorber 61 is provided below the platen 60 in the gravitational direction. The first ink absorber 61 has a shape and is disposed relative to the first waste ink tray 64 as illustrated in FIG. 7, and includes a plurality of (four) contact portions 61a that hang down through hole portions provided in the platen 60 toward the first waste ink tray 64 and that are in contact with the first waste ink tray 64.

In this manner, the first ink absorber 61 preferably includes the contact portions 61a that are in contact with the first waste ink tray 64. With such a configuration, the waste ink can be efficiently moved from the first ink absorber 61 to the first waste ink tray 64 via the contact portions 61a, and the waste ink can be particularly efficiently collected. In addition, by moving the waste ink from the first ink absorber 61 to the first waste ink tray 64 via the contact portions 61a, it is possible to suppress the waste ink bouncing back and making the inside of the device dirty when the waste ink is moved from the first ink absorber 61 to the first waste ink tray 64. In this embodiment, the first ink absorber 61 includes the four contact portions 61a, but the number and the arrangement of the contact portions 61a are not particularly limited.

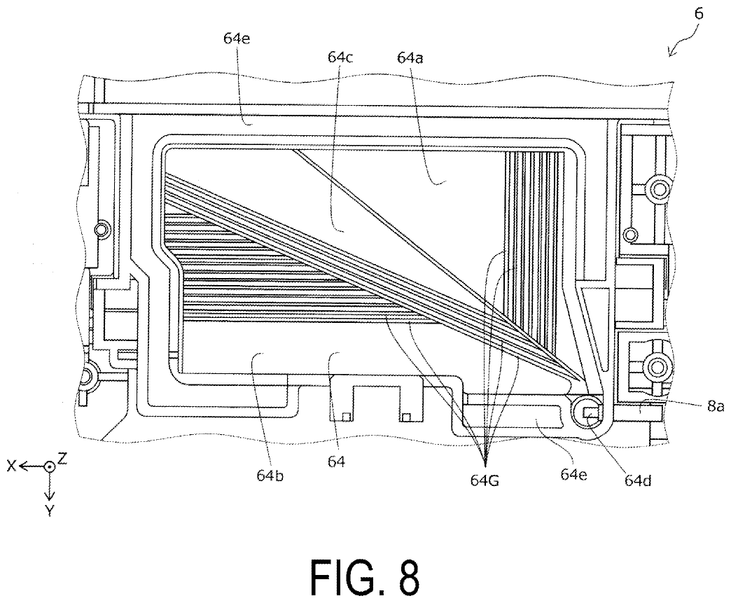

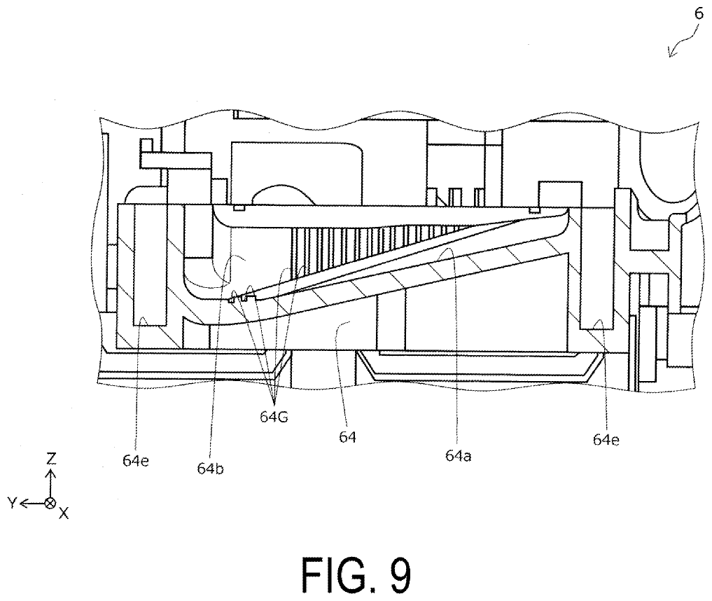

Here, a detailed configuration of the first waste ink tray 64 will be described. The first waste ink tray 64 according to the embodiment includes a first inclined surface 64a, a second inclined surface 64b, and a third inclined surface 64c as illustrated in FIG. 8 and the like. The first inclined surface 64a, the second inclined surface 64b, and the third inclined surface 64c have different inclination directions and different inclination angles. A plurality of grooves 64G are formed in each of the first inclined surface 64a, the second inclined surface 64b, and the third inclined surface 64c. Each of the first inclined surface 64a, the second inclined surface 64b, and the third inclined surface 64c is configured to be lowered toward a first discharge port 64d illustrated in FIG. 8, and each of the grooves 64G also extends toward the first discharge port 64d. As illustrated in FIG. 9 and the like, the first waste ink tray 64 according to the embodiment has a shape in which most of the waste ink receiving region is configured as an inclined surface and there is almost no horizontal surface, but may have a structure in which many horizontal ink receiving surfaces are present and a plurality of inclined surfaces are present in the remaining region. However, as in the embodiment, it is preferable to adopt a configuration in which the inclination starts from the wall surrounding the waste ink receiving region and thus there is substantially no horizontal surface (a configuration in which the waste ink is guided to the discharge port by the inclined surfaces and the inclined valley formed between the inclined surfaces).

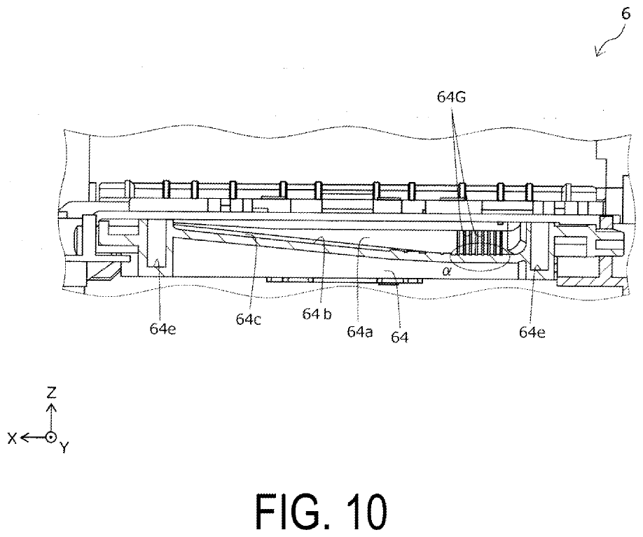

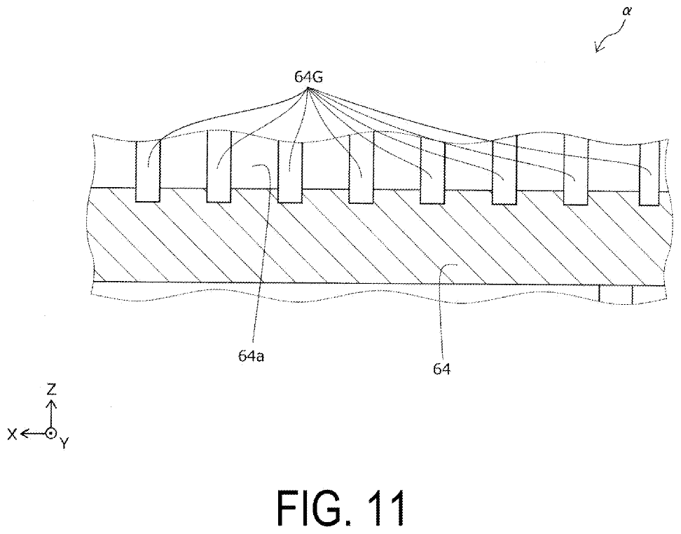

In detail, as illustrated in FIG. 9, the first inclined surface 64a is inclined in the Y-direction corresponding to the transport direction of the medium. Here, the inclination angle of the first inclined surface 64a is 9°. As illustrated in FIG. 10, the second inclined surface 64b is inclined in the X-direction corresponding to the width direction intersecting the transport direction of the medium. Here, the inclination angle of the second inclined surface 64b is 5.3°. The third inclined surface 64c is provided between the first inclined surface 64a and the second inclined surface 64b, and is inclined in both the transport direction of the medium and the width direction. Here, the inclination angle of the third inclined surface 64c is 6°. As illustrated in FIG. 11, the plurality of grooves 64G are arranged at equal intervals, the pitch is 1.5 mm, the width is 0.5 mm, and the depth is 0.3 mm. The same applies not only to the grooves 64G of the first inclined surface 64a but also to the grooves 64G of the second inclined surface 64b and the third inclined surface 64c.

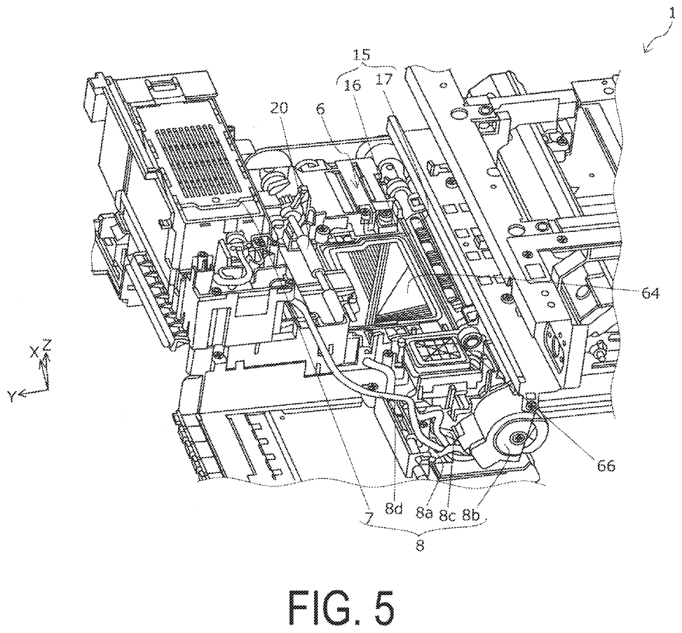

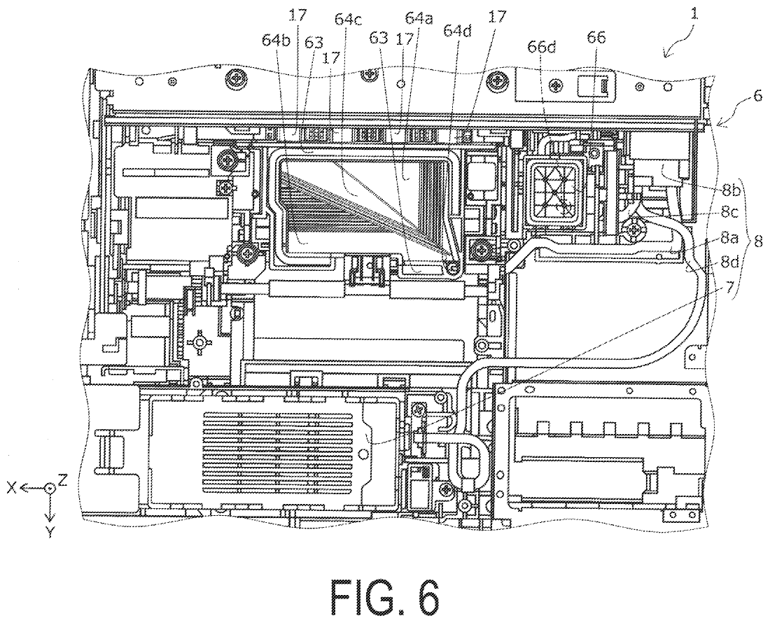

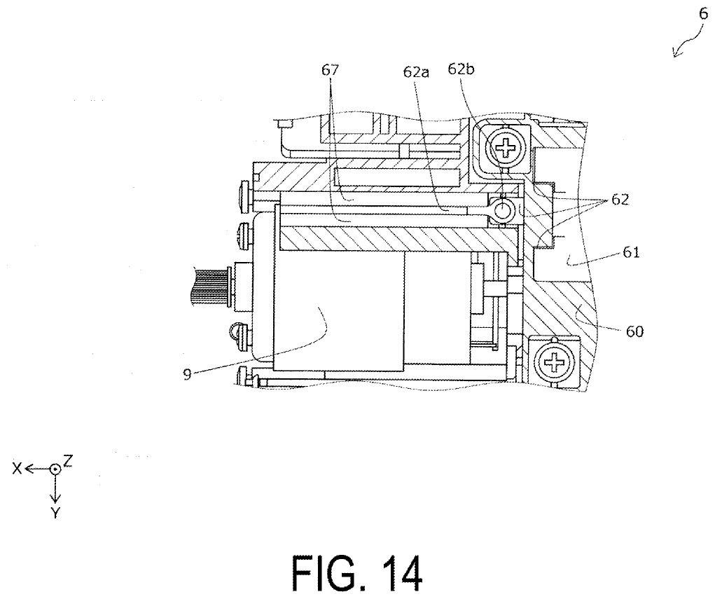

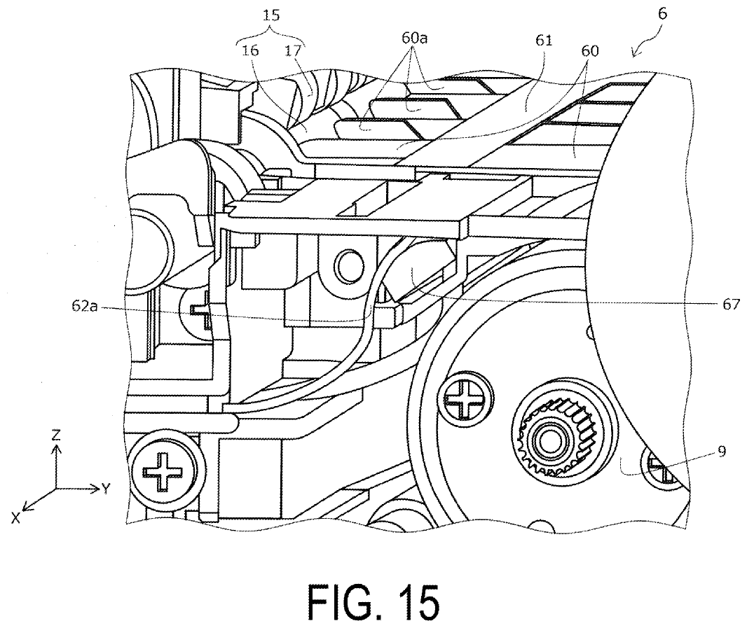

The first discharge port 64d is coupled to a first tube 8a illustrated in FIGS. 5 and 6. The first tube 8a is coupled to a tube pump 8b and is also coupled to a waste liquid tube 8d extending to a waste ink storage unit 7. The recording device 1 according to the embodiment includes a motor 9 that rotates the driving roller 16 and the driving roller 19 and that is illustrated in FIGS. 14 and 15, and the driving force of the motor 9 is also transmitted to the tube pump 8b. The motor 9 drives the tube pump 8b and squeezes the first tube 8a while rotationally moving a ball (not illustrated) provided inside the tube pump 8b, and thus the waste ink inside the first tube 8a is fed to the waste ink storage unit 7 via the waste liquid tube 8d. The first tube 8a, the tube pump 8b, the waste liquid tube 8d, and the waste ink storage unit 7 can be regarded as constituting a discharge mechanism 8 that discharges, from the first discharge port 64d, the waste ink in the first waste ink tray 64.

As described above, the recording device 1 according to the embodiment is a recording device capable of performing borderless recording for forming an image up to the edge of the medium. Moreover, the recording device 1 includes the ejecting head 4 ejecting ink onto the medium, the first ink absorber 61 absorbing, of the ink ejected from the ejecting head 4 during borderless recording, waste ink ejected to a position beyond the edge of the medium, and the platen 60 supporting the first ink absorber 61 and also supporting the medium during the borderless recording. The recording device 1 also includes the first waste ink tray 64 that includes the first discharge port 64d discharging the waste ink and that receives the waste ink flowing out from the first ink absorber 61, and the discharge mechanism 8 discharging, from the first discharge port 64d, the waste ink received by the first waste ink tray 64. The first waste ink tray 64 includes, as the plurality of inclined regions inclined to guide the waste ink to the first discharge port 64d, the first inclined surface 64a, the second inclined surface 64b, and the third inclined surface 64c. The plurality of inclined regions have different inclination directions.

With such a configuration, the waste ink received by the first waste ink tray 64 can be effectively guided to the first discharge port 64d. Further, the valley-shaped portion sandwiched between the plurality of inclined regions is formed, and thus the waste ink can be particularly efficiently made to flow toward the first discharge port 64d. Thus, the waste ink caused by the borderless recording can be efficiently collected. The term “inclination” used herein means inclination with respect to the horizontal direction.

As described above, the first waste ink tray 64 includes, as the inclined regions, the first inclined surface 64a inclined in the transport direction of the medium and the second inclined surface 64b inclined in the width direction intersecting the transport direction of the medium. Thus, the waste ink can be effectively guided to the first discharge port 64d from greatly different directions, and the waste ink can be particularly efficiently collected. In addition, since the inclined regions are configured as surfaces, it is possible to suppress the first waste ink tray 64 becoming bulky and large. Note that the term “surface” used herein means a configuration in which some unevenness is allowed, such as a configuration including the grooves 64G as in the embodiment. Here, the expression “inclined in the transport direction of the medium” can be understood as being inclined as viewed from the width direction, and the expression “inclined in the width direction” can be understood as being inclined as viewed from the transport direction of the medium.

The first waste ink tray 64 further includes the third inclined surface 64c, in addition to the first inclined surface 64a and the second inclined surface 64b. Since the third inclined surface 64c is further provided in addition to the first inclined surface 64a and the second inclined surface 64b, the area of the second inclined surface 64b having a small inclination angle is reduced. The area of the second inclined surface 64b having a small inclination angle is reduced, and thus the waste ink can be particularly effectively guided to the first discharge port 64d, and the waste ink can be particularly efficiently collected.

As described above, each of the first inclined surface 64a, the second inclined surface 64b, and the third inclined surface 64c, which are the inclined regions of the first waste ink tray 64, is provided with the plurality of grooves 64G extending in the inclination direction. In this manner, at least one of the plurality of inclined regions is preferably provided with the grooves along the inclination direction. Providing the grooves 64G enables the waste ink to be effectively guided to the first discharge port 64d by, for example, the capillary effect, and the waste ink can be particularly efficiently collected.

In addition, in the first waste ink tray 64 according to the embodiment, all of the first inclined surface 64a, the second inclined surface 64b, and the third inclined surface 64c, which are the plurality of inclined regions, are fluorine-coated. For this reason, the waste ink easily flows toward the first discharge port 64d at any of the first inclined surface 64a, the second inclined surface 64b, and the third inclined surface 64c. However, the present disclosure is not limited to such a configuration, and the fluorine coating may be applied to only one of the plurality of inclined regions, or the fluorine coating may be applied to none of the plurality of inclined regions.

As described above, the discharge mechanism 8 according to the embodiment includes the waste ink storage unit 7 that stores the waste ink, and the first tube 8a that couples the first discharge port 64d and the waste ink storage unit 7. With such a configuration, for example, by making the first tube 8a flexible, it is possible to increase the degree of freedom in the arrangement of the waste ink storage unit 7.

Further, the discharge mechanism 8 according to the embodiment includes the tube pump 8b that is a pump that accelerate a flow of the waste ink from the first discharge port 64d to the waste ink storage unit 7 via the first tube 8a. Thus, the waste ink can be particularly quickly and efficiently discharged to the waste ink storage unit 7 by using the tube pump 8b. In addition, use of the tube pump 8b enables the waste ink storage unit 7 to be disposed above the first discharge port 64d in the gravitational direction, and can increase the degree of freedom in the device configuration. Although the tube pump 8b is used as a pump in the embodiment, the type of the pump is not particularly limited.

As described above, the ejecting head 4 according to the embodiment is configured to eject ink onto the medium while reciprocating. In addition, the ejecting head 4 according to the embodiment is positioned at a home position that is a position in the −X direction in a reciprocating movement range during non-recording, and as illustrated in FIGS. 5 and 6 and the like, a second waste ink tray 66 is provided at the home position. The second waste ink tray 66 receives, as waste ink, ink ejected from the ejecting head 4 in a maintenance operation and the like of the ejecting head 4. As illustrated in FIG. 6, the second waste ink tray 66 includes a second discharge port 66d therein. The discharge mechanism 8 includes a second tube 8c that couples the second discharge port 66d and the waste ink storage unit 7 via the waste liquid tube 8d. Here, the tube pump 8b also has a role of accelerating a flow of the waste ink from the second discharge port 66d to the waste ink storage unit 7 via the second tube 8c. For this reason, the recording device 1 according to the embodiment does not need to be provided with a plurality of pumps, and thus upsizing of the device can be suppressed.

In the recording device 1 according to the embodiment, as illustrated in FIG. 4, a width W1 of the first waste ink tray 64 as viewed from the transport direction of the medium corresponding to the Y-axis direction is narrower than a width W2 of the first ink absorber 61 as viewed from the transport direction of the medium. For this reason, in the recording device 1 according to the embodiment, the first waste ink tray 64 can be downsized, and thus the entire device can be downsized.

In the recording device 1 according to the embodiment, as described above, the first ink absorber 61 is provided with the contact portions 61a, and the waste ink absorbed by the first ink absorber 61 is moved to the first waste ink tray 64 via the contact portions 61a. Thus, the width W1 of the first waste ink tray 64 can be easily configured to be narrower than the width W2 of the first ink absorber 61. However, the present disclosure is not limited to such a configuration. The first ink absorber 61 may be provided with a region that does not come into contact with the first waste ink tray 64 but hangs down toward the first waste ink tray 64 so that the region enables the waste ink to move from the first ink absorber 61 to the first waste ink tray 64, and the width W1 of the first waste ink tray 64 may be narrower than the width W2 of the first ink absorber 61. Furthermore, the width W1 of the first waste ink tray 64 may be configured to be narrower than the width W2 of the first ink absorber 61 without provision of the contact portions 61a and the region that hangs down toward the first waste ink tray 64.

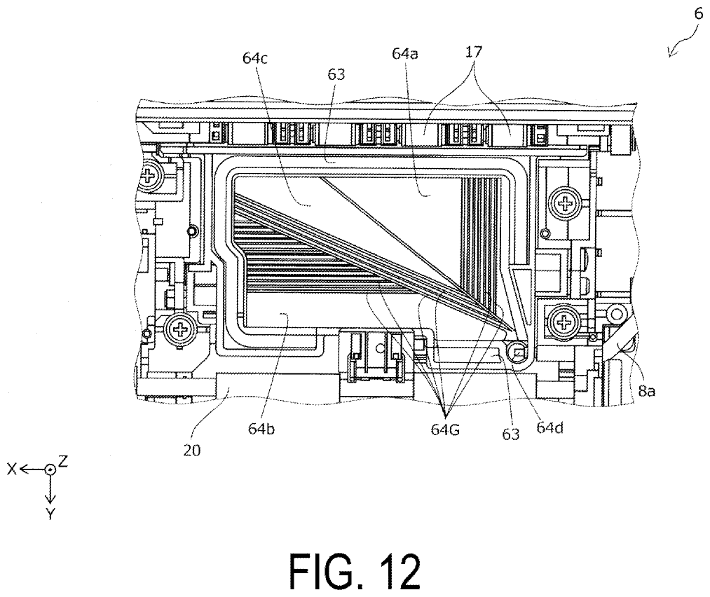

In the recording device 1 according to the embodiment, as illustrated in FIG. 12 and the like, a second ink absorber 63 is provided around the first waste ink tray 64 as viewed from the ink ejection direction corresponding to the Z-axis direction. The second ink absorber 63 is accommodated in a housing groove 64e provided at the first waste ink tray 64 illustrated in FIGS. 8 to 10. Thus, in the recording device 1 according to the embodiment, for example, when the recording device 1 is moved in a state in which the waste ink remains in the first waste ink tray 64, it is possible to suppress the waste ink leaking from the first waste ink tray 64 and making the inside of the device dirty.

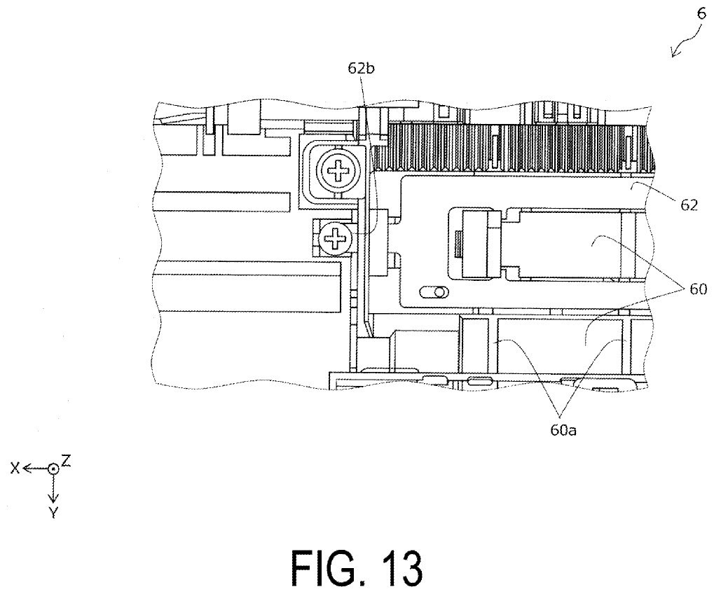

Moreover, in the recording device 1 according to the embodiment, as illustrated in FIG. 4 and FIG. 13, which illustrates a state in which the first ink absorber 61 is removed, an electrode plate 62 including an electrode terminal 62b coupled to a wiring line 62a illustrated in FIGS. 14 and 15 is provided at a position between the platen 60 and the first ink absorber 61. By applying a voltage to the electrode plate 62, it is possible to direct ink mist generated by ejection of the ink toward the electrode plate 62. Since the first ink absorber 61 is disposed on the electrode plate 62 as described above, the ink mist can be directed toward the first ink absorber 61 by applying a voltage to the electrode plate 62. In the recording device 1 according to the embodiment, as illustrated in FIGS. 14 and 15, a third ink absorber 67 is provided along the wiring line 62a. Thus, in the recording device 1 according to the embodiment, it is possible to suppress the waste ink leaking from the first waste ink tray 64 along the wiring line 62a and making the inside of the device dirty. In the embodiment, the second ink absorber 63 and the third ink absorber 67 are made of the same material as the first ink absorber 61, but at least one of the first ink absorber 61, the second ink absorber 63, or the third ink absorber 67 may be made of a different material.

Note that the disclosure is not limited to the aforementioned embodiment, and many variations are possible within the scope of the disclosure as described in the appended claims. It goes without saying that such variations also fall within the scope of the disclosure.

What is claimed is:

1. A recording device configured to perform borderless recording for forming an image up to an edge of a medium, the recording device comprising:
an ejecting head configured to eject ink onto the medium;
a first ink absorber, during the borderless recording, disposed at a position facing the ejecting head and configured to absorb waste ink, of the ink, ejected to a position beyond the edge;
a platen configured to support the first ink absorber, and support the medium during the borderless recording;
a first waste ink tray including a first discharge port configured to discharge the waste ink, the first waste ink tray being configured to receive the waste ink flowing out from the first ink absorber; and
a discharge mechanism configured to discharge, from the first discharge port, the waste ink received by the first waste ink tray, wherein
the first waste ink tray includes a plurality of inclined regions inclined to guide the waste ink to the first discharge port, and each of the plurality of inclined regions has a different inclination direction.

2. The recording device according to claim 1, comprising
a transport unit configured to transport the medium in a transport direction, wherein
the first waste ink tray includes, as the plurality of inclined regions, a first inclined surface inclined in the transport direction and a second inclined surface inclined in a width direction intersecting the transport direction.

3. The recording device according to claim 1, wherein
the first waste ink tray includes, in at least one of the plurality of inclined regions, a groove extending along the inclination direction.

4. The recording device according to claim 1, wherein
the discharge mechanism includes a waste ink storage unit configured to store the waste ink, and a first tube coupling the first discharge port and the waste ink storage unit.

5. The recording device according to claim 4, wherein
the discharge mechanism includes a pump configured to accelerate a flow of the waste ink from the first discharge port to the waste ink storage unit via the first tube.

6. The recording device according to claim 5, wherein
the ejecting head is configured to eject the ink onto the medium while reciprocating, the ejecting head being located at a home position during non-recording,
a second waste ink tray configured to receive the ink ejected from the ejecting head as waste ink is provided at the home position,
the second waste ink tray includes a second discharge port,
the discharge mechanism includes a second tube coupling the second discharge port and the waste ink storage unit, and
the pump also has a role of accelerating a flow of the waste ink from the second discharge port to the waste ink storage unit via the second tube.

7. The recording device according to claim 1, wherein
the first ink absorber includes a contact portion being in contact with the first waste ink tray.

8. The recording device according to claim 2, wherein
a width of the first waste ink tray when viewed from the transport direction is narrower than a width of the first ink absorber when viewed from the transport direction.

9. The recording device according to claim 1, comprising
a second ink absorber provided around the first waste ink tray when viewed from an ejection direction of the ink.

10. The recording device according to claim 1, comprising
an electrode plate including an electrode terminal coupled to a wiring line, the electrode plate being provided at a position between the platen and the first ink absorber, and
a third ink absorber provided along the wiring line.
